(19) United States
(12) Patent Application Publication
(10) Pub. No.: US 2019/0156015 A1
(43) Pub. Date: May 23, 2019

(54) SMM PROTECTION UTILIZING RING SEPARATION AND SMI ISOLATION

(71) Applicants: Kirk D. Brannock, Gaston, OR (US); Jiewen Yao, Shanghai (CN)

(72) Inventors: Kirk D. Brannock, Gaston, OR (US); Jiewen Yao, Shanghai (CN)

(21) Appl. No.: 16/236,405

(22) Filed: Dec. 29, 2018

Related U.S. Application Data
(60) Provisional application No. 62/722,103, filed on Aug. 23, 2018.

(51) Int. Cl. G06F 21/44; G06F 9/48

(52) U.S. Cl. CPC G06F 21/44; G06F 9/4812

(57) ABSTRACT

In one embodiment, a processor comprises a plurality of system resources accessible to processes executed at a first privilege level but generally not accessible to processes executing at a second privilege level; a memory to store an access control policy; and an execution unit to: execute a system management interrupt (SMI) handler at the second privilege level; and execute a policy manager at the first privilege level, the policy manager to detect a request from the SMI handler to access a first system resource of the plurality of system resources; and access the first system resource on behalf of the SMI handler in response to a determination that the access control policy allows the SMI handler to access the first system resource.

### RELATED APPLICATION

This application claims benefit under 35 U.S.C. § 119(e) of U.S. Provisional Application Ser. No. 62/722,103, entitled “SMM PROTECTION UTILIZING RING SEPARATION AND SMI ISOLATION” filed Aug. 23, 2018.

### BACKGROUND

System Management Mode (SMM) is an operating mode of x86 central processor units (CPUs) in which normal execution, including the operating system, is suspended. An alternate software system which may reside in the computer's firmware or a hardware-assisted debugger is then executed with high privileges. In general, SMM is intended for use only by system firmware, not by applications software. The SMM may be entered through a System Management Interrupt (SMI). In at least some implementations, the SMM code is executed in a separate address space inaccessible to other operating modes of a CPU.

The runtime SMM code may have the highest privilege to access any system resources, such as physical memory, memory-mapped input/output (MMIO), input/output (I/O), model-specific registers (MSRs), and a Save State Register, or other system resources. However, a malicious or buggy SMI handler may break the integrity of the operating system or Virtual Machine Monitor (VMM) if the SMI handler can access all the system resources.

### BRIEF DESCRIPTION OF THE DRAWINGS

Like reference numbers and designations in the various drawings indicate like elements.

FIG. 1 illustrates a system to provide SMM protection utilizing ring separation in accordance with certain embodiments.

FIG. 2 illustrates a conceptual organization of the SPS runtime in accordance with certain embodiments.

FIG. 3 illustrates a flow of a BIOS boot time (e.g., as performed during a power-on self-test) in accordance with certain embodiments.

FIG. 4 illustrates a flow for an SMM runtime in accordance with certain embodiments.

FIG. 5 illustrates a flow for handling an SMM exception in accordance with certain embodiments.

FIG. 6 illustrates a system for SMM with SMI isolation in accordance with certain embodiments.

FIG. 7 illustrates an SPS-SX supporting multiple SMI handler domains in accordance with certain embodiments.

FIG. 8 illustrates a runtime for a system implementing an SPS-SX in accordance with certain embodiments.

FIGS. 9 and 10 illustrate flows for performing a function by an SPS service handler in accordance with certain embodiments

FIGS. 11 and 12 illustrate flows for performing a function by an SPS service handler in a system comprising multiple SMI handler domains in accordance with certain embodiments.

FIG. 13 depicts a flow for using a policy manager to control access to resources by an SMI handler in accordance with certain embodiments.

FIG. 14A is a block diagram illustrating both an exemplary in-order pipeline and an exemplary register renaming, out-of-order issue/execution pipeline in accordance with certain embodiments.

FIG. 14B is a block diagram illustrating both an exemplary embodiment of an in-order architecture core and an exemplary register renaming, out-of-order issue/execution architecture core to be included in a processor in accordance with certain embodiments;

FIGS. 15A-B illustrate a block diagram of a more specific exemplary in-order core architecture, which core would be one of several logic blocks (potentially including other cores of the same type and/or different types) in a chip in accordance with certain embodiments;

FIG. 16 is a block diagram of a processor that may have more than one core, may have an integrated memory controller, and may have integrated graphics in accordance with certain embodiments;

FIGS. 17, 18, 19, and 20 are block diagrams of exemplary computer architectures in accordance with certain embodiments; and

FIG. 21 is a block diagram contrasting the use of a software instruction converter to convert binary instructions in a source instruction set to binary instructions in a target instruction set in accordance with certain embodiments.

Like reference numbers and designations in the various drawings indicate like elements.

### DETAILED DESCRIPTION

Various SMM implementations may include some protection against malicious or buggy SMI handlers. For example, in SMM memory protection, memory restriction may be utilized to force an SMI handler to only access Advanced Configuration and Power Interface (ACPI) reserved memory, ACPI Non-Volatile Sleeping (NVS) memory, or runtime memory. Furthermore, the SMM page table may be read-only. However, such implementations do not address the concern of modifications to the I/O, MSRs, and the register context (such as the Save State Register).

Various embodiments of the present disclosure may provide a lightweight way of protecting system resources, such as I/O, MSRs, or register context for an operating system or VMM. In a particular embodiment, an IA32 Ring-Based Protection in SMM may be provided, although any of the embodiments described herein may be adapted to any suitable processor architecture. Protection rings (also referred to as a hierarchical protection domain) include mechanisms to protect data and functionality from faults and malicious behavior. A protection ring is a level of privilege within a computer system architecture. A privilege level may control the access of the program currently running on the processor to resources such as memory regions, I/O ports, and special instructions. A resource available to level n is also generally available to levels 0 to n−1 (thus the privilege levels may be viewed as rings). When a lesser privileged process tries to access a higher privileged process, a fault (e.g., a general protection fault) or exception may be reported by the operating system.

In some embodiments, the protection rings may be hardware-enforced by a CPU architecture that provides different CPU modes at the hardware or microcode level. The rings may be arranged from most privileged (e.g., the ring with the lowest number such as ring 0) to least privileged (e.g., the ring with the highest number, such as ring 3), where lower privileged rings provide access to less system resources than higher privileged rings. In a particular embodiment, a CPU architecture may implement ring 0, ring 1, ring 2, and ring 3 (or equivalent) privilege levels. In particular embodiments, a CPU architecture may implement an application privilege level (the least privileged level), an operating system privilege level, and a hypervisor privilege level (the most privileged level). CPU architectures may support any suitable number of rings.

An operating system may or may not utilize all rings enabled by the CPU architecture. For example, many operating systems use only two rings, with ring 0 corresponding to kernel/executive mode and ring 3 corresponding to user mode. To perform specialized functions, user mode code may be required to perform a system call into supervisor mode or even to the kernel space where trusted code of the operating system may perform the requested task and return the execution back to the user mode. As another example, other operating systems may use ring 0 for kernel code and device drivers, ring 2 for privileged code (e.g., user programs with I/O access permissions), and ring 3 for unprivileged code (e.g., most user programs).

The CPU hardware may restrict the manner in which control can be passed from one ring to another and provide restrictions on the types of resource (e.g., memory) access that may be performed by each ring. For example, a gate structure referenced by a call instruction may transfer control in a secure way towards predefined entry points in lower-level (more trusted) rings. In some embodiments, the most privileged ring may be given special capabilities such as real memory addressing that bypasses virtual memory hardware.

In a particular embodiment, all of the SMI handlers and SMM rendezvous may be deprivileged to Ring 3, a set of policies on which system resources (e.g., I/O, MSR, Register Context, or other resources) may be accessed by SMI handlers may be defined, and an SMM policy shim (SPS) may be granted ring 0 access to enforce the policy. In a particular embodiment, the policy is set using the basic input/output system (BIOS) power-on self-test (POST) code. This system protection may be used in conjunction with a memory protection scheme, such as the one described above (e.g., SMM memory protection) to provide improved protection of system resources. Various embodiments may provide a relatively simple and fast way to protect the system (e.g., from attacks or bugs of SMI handlers) and may harden SMI handlers against code inject and malicious execution. Particular embodiments may also have a relatively small storage footprint.

A particular embodiment may provide ring separation in SMM to de-privilege SMI handlers to ring 3. Various embodiments may utilize a lightweight SMM policy shim executed by the processor to enforce the access control policy in SMM ring 0. One embodiment may use a simple configuration table (referred to herein as “SMM_INFO_TABLE”) for the policy definition. Some embodiments may utilize an SMM policy shim exception handler to enforce MSR access control. Various embodiments may utilize an SMM policy shim to enforce protection for non-save state registers such as MMX, XMM, YMM, ZMM or other registers used in conjunction with single instruction, multiple data (SIMD) instructions (e.g., Advanced Vector Extensions instructions) or other non-save state registers (i.e., registers that are not used to store a processor state during a context switch). In another embodiment, an SMM policy shim may enforce control flow enforcement technology (CET) to prevent return-oriented programming (ROP)/jump-oriented programming (JOP) attacks. In some embodiments, a resume from SMM (RSM) instruction may be deprivileged to enforce an SMM context restore (whereas other systems may allow execution of an RSM instruction at any privilege level).

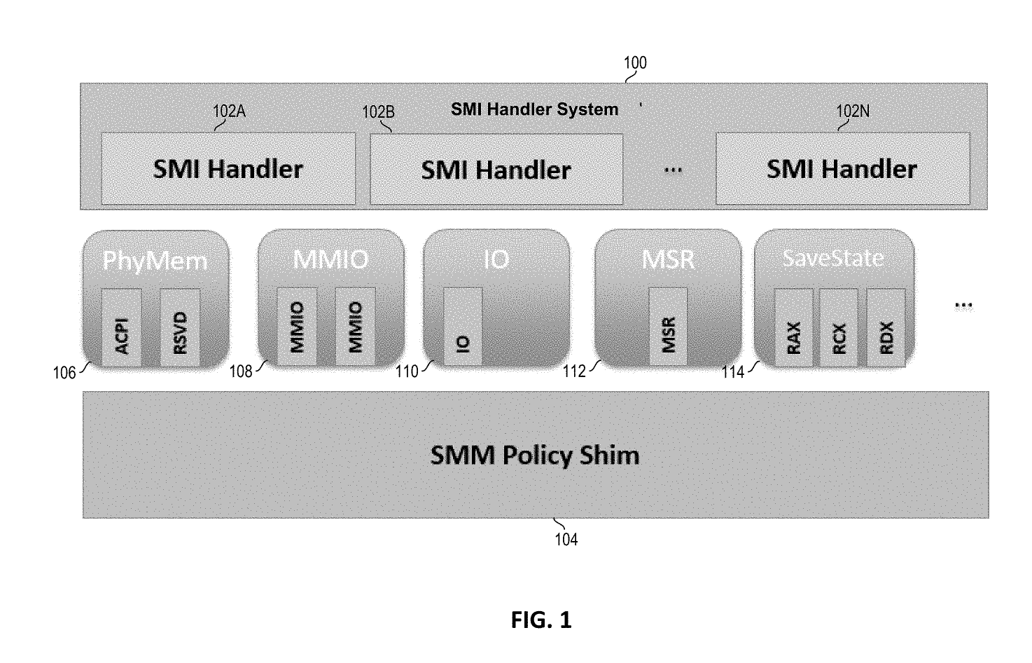

FIG. 1 illustrates a system to provide SMM protection utilizing ring separation in accordance with certain embodiments. The system comprises an SMI handler domain 100 (comprising any number of SMI handlers 102A-102N, collectively referred to as SMI handlers 102), an SMM policy shim (SPS) 104, and system resources, such as physical memory 106, MMIO 108, I/O 110, MSR 112, and SMM Save State register 114. The SPS 104 runs in a ring 0 environment. The SMI handlers 102 are de-privileged to ring 3 by the processor. In various embodiments, SMI handler 102 runs in system management RAM (SMRAM) or an area of DRAM (on a DIMM along with the system memory) that isn't visible unless the processor is in SMM.

The system resources, such as physical memory 106, MMIO 108, I/O 110, MSR 112, and SMM Save State register 114 are partitioned into two categories: SMI accessible resources and SMI non-accessible resources. During system boot, SMI handler domain 100 (or individual SMI handlers 102) declares the resources it will use during operating system runtime. The SPS 104 records this policy setting and enforces the policy setting during operating system runtime. Although a single SMI handler 102 is referred to in the discussion below, the discussion may apply to the entire SMI handler domain 100 (or to one or more of the SMI handlers 102).

The SPS may utilize various methods to perform the policy enforcement for the resources:

Physical memory 106: The SMM policy shim uses a page table that is specific to the SMI handler 102 (i.e., separate from a page table of the operating system) to only expose the pages required by the SMI handler 102. The non-required pages are marked as not present in the page table (in other words there is no mapping for these pages in the page table for the SMI handler 102). The page table of the SMI handler may be read-only in some embodiments. The SPS 104 may also block the SMI handler 102 from updating a control register and an extended feature enable register (e.g., control register (CR)0, CR3 (which may contain the physical base address of the page table), CR4, or IA32_EFER) to prevent paging constraints from being bypassed. This capability may be implemented in software (e.g., using the SPS 104, which may update the page table in ring 0 if needed while the page table may not be updated in the privilege level in which the SMI handler 102 is running) or in the hardware itself (e.g., even ring 0 may be blocked from changing the page table by deprivileging ring 0 with respect to these registers, e.g., by writing to an MSR). In a particular embodiment, the page table for the SMI handler 102 is stored in SMRAM. The page table may map logical addresses to addresses of physical memory 106 (e.g., system memory coupled to the processor). In some embodiments, the physical memory 106 may comprise DRAM or other suitable memory type.

MMIO 108: The MMIO may be protected using any of the techniques used to protect physical memory 106. The SPS 104 may utilize the page table for the SMI handler 102 to enforce the policy (e.g., by not mapping MMIO that should not be accessible to the SMI handler 102). In various embodiments, policy granularity as small as bit or byte may be implemented. For example, a portion (e.g., some registers of an I/O device) of a page mapped to MMIO may be accessible to the SMI handler 102, while the rest of the page is not. In other embodiments, accessibility may be determined on a page by page basis. In various embodiments, when the page table mapping for a particular page is created, a page that should not be directly accessible to the SMI handler 102 may be designated as a supervisor page so that ring 3 code can't directly access the page. Thus, the policy may specify which portions of the MMIO 108 are accessible to the SMI handler using any suitable granularity.

In MMIO, memory of an I/O device may be mapped into the CPU's address space, thus the processor and I/O device are mapped to each other using the common memory address space. The CPU instructions and bus used to access the physical memory may also be used to access memory of I/O devices (i.e., MMIO 108).

I/O: When SPS 104 switches (e.g., passes control) to SMI handler 102, a ring 3 task state segment (TSS) may be used to control access to I/O. For I/O ports, the SMM policy shim may maintain a TSS I/O-bitmap that can permit or deny ring 3 I/O instructions (from an SMI handler 102). In a particular embodiment, instead of faulting every time an I/O port is accessed, if the bit for the I/O port bit is set in the TSS I/O bitmap, access to the I/O port may be granted. In one embodiment, all I/O access may be trapped with sub-granularity of I/O access by bit.

MSR 112: The policy governing access to the MSRs may be referred to herein as MsrPolicy. A CPU may include a plurality of MSRs 112, which may be distinguished from general purpose registers and floating point registers of the CPU. In a particular embodiment, the CPU may implement two instructions for accessing these MSRs: a Read from Model Specific Register (RDMSR) instruction and a Write to Model Specific Register (WRMSR). MSRs may be organized into an array of registers to serve any suitable functions. For example, they may interact with a bus, change power states, or perform operations that are specific to a CPU model (or group of CPU models). MSRs allow a CPU designer to add microarchitecture functionality without having to add an additional instruction to the CPU instruction set.

The SMM policy shim 104 may maintain a list of MSR access policy and setup an exception handler. RDMSR and WRMSR may be supervisor or privileged instructions (e.g., these instructions may not be legal from ring 3). When an SMI handler 102 utilizes a RDMSR instruction and/or a Write to Model Specific Register WRMSR instruction to access an MSR, a general protection (GP) fault is triggered. The SMM policy shim exception handler then looks up the MSR access policy list and determines whether this MSR access is granted or denied. If the access is granted, the SMM policy shim executes the MSR access instruction in ring 0 and either returns data read from the MSR back to the ring 3 SMI handler (in the case of RDMSR) or writes data to the MSR (in the case of WRMSR). If the access is denied, the SMM policy shim returns back to the SMI exception handler without executing the MSR access instruction. The access policy may be Read, Write, Scrub, or Save/Restore. Scrub may represent a policy in which the SMI handler 102 may access an MSR, but the MSR must be scrubbed first (e.g., overwritten with blank data because the MSR may contain sensitive data, such as operating system context). Policies may be set on a per-MSR basis. Various embodiments may even have bit level granularity control (i.e., different policies may be set for different bits within the same MSR).

SMM Save State register 114: The policy governing access to the save state may be referred to herein as SaveStatePolicy, When an SMI occurs, a processor may switch context (i.e., change execution state). The context of the operating system (e.g., at least the data stored in some general purpose registers) is saved (e.g., by SMM policy shim 104) and may be restored once SMM is exited. In memory based save state, the context may be saved, e.g., into DRAM or other memory external to the CPU. In register based save state (e.g., MSR base state save), the context may be stored in internal memory inside of the CPU (e.g., SMM Save State register 114), such as SMRAM or a special register bank and the saved area may be exposed to SMI handler 102 via a bank of registers (e.g., MSRs). The registers that are saved may also be scrubbed to prevent the SMI handler 102 from accessing sensitive data. After the SMI handler 102 is done running, an RSM (return from SMM) instruction may be issued and the CPU context may be restored (e.g., from the save state area into CPU registers).

If memory based save state is used, the SMM policy shim 104 can save the SMM save state content at SMI entry. Then at SMI exit, the SMM policy shim 104 can decide which region to restore based upon the save state policy. Access to the save state information may be prevented by policy (e.g., which registers are saved and/or scrubbed may be specified by the policy). For example, if SMI handler 102 only requests to access particular general purpose registers (e.g., RAX, RCX, and RDX), the SMM policy shim 102 may then restore any other register, such as RBX, R8, or R9.

In some embodiments, if MSR based save state is supported, the SMM policy shim 104 can grant or deny the MSR access based upon save state policy. Thus, the MSR access policies discussed above may apply when MSR based save state is used. Such an implementation may also provide bit level granularity control in some embodiments.

Other registers: The SMM policy shim can save, scrub, and restore to maintain the integrity and/or confidentiality of the operating system context. Particular embodiments may provide bit level granularity control. Such policies may be applied to any suitable registers, such as AVX registers (e.g., MMX/XMM/YMM/ZMM/etc.). Because such registers may not be automatically saved by the CPU into the state save, when SMI handler is executed such registers may have operating system context. Accordingly, if such registers need to be hidden from a ring 3 SMI handler (e.g., 102), then these registers may be saved, scrubbed, used by the SMI handler 102, and then the original contents may be restored when SMM is exited. The policy governing access to these registers may be referred to herein as Register policy.

In a particular embodiment, these access policies and other information utilized in SMM (e.g., page table, global descriptor table (GDT), interrupt descriptor table (IDT), TSS I/O bitmap, MsrPolicy, SaveStatePolicy, Register policy) are referred by an SMM_INFO_TABLE structure. Various embodiments include a mechanism for the processor to discover the location of the SMM_INFO_TABLE by using a locked hardware configuration (e.g., information allowing identification of the SMM_INFO_TABLE may be stored in memory or a register that is not editable in ring 3 by the SMI handler 102). For example, a pointer to the SMM_INFO_TABLE may be embedded to a fixed offset from the SMM entrypoint or stored in a special lockable MSR (e.g., an MSR that can't be edited except using a special privilege or upon reset).

The SMI handler 102 may define its requested policies during an initialization phase. Once the policies are defined, the policy page will be read only. In an embodiment, the policy itself is not embedded in the SMM_INFO_TABLE, but embedded in the code referred by the SMM_INFO_TABLE (e.g., the SMM_INFO_TABLE may include pointers to the policies rather than the policies themselves).

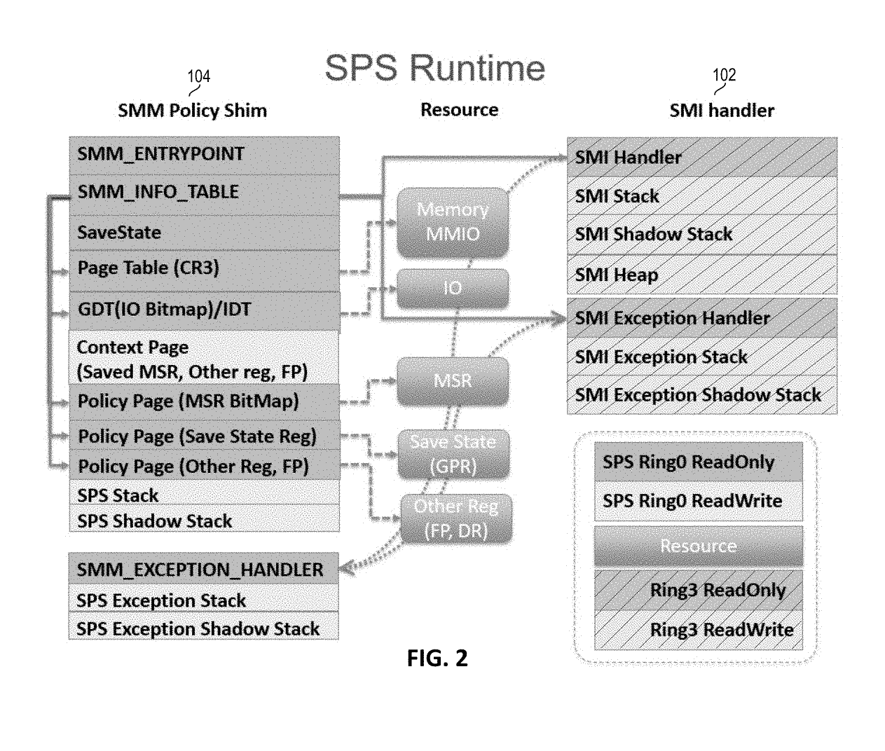

FIG. 2 illustrates a conceptual organization of the SPS runtime in accordance with certain embodiments. FIG. 2 does not necessarily represent the memory map in the SMM, although in some embodiments various components depicted therein may be organized within memory in a similar fashion to that shown in FIG. 2. FIG. 2 depicts elements of SMM policy shim 104, resources 106, 108, 110, 112, 114, and other resources, elements of SMI handler 102, and a key 202 depicting example privilege levels for the various elements.

The SMM_ENTRYPOINT of the SPS 104 is the location the processor begins execution when it takes an SMI. In a particular embodiment, the SMM_ENTRYPOINT address is equal to or derived from (e.g., by adding an offset to) an SMBASE value which is stored in a register (e.g., in an MSR).

When an SMI is taken, execution begins in SMM in a full privilege mode. The SPS 104 runs and turns on paging and protected mode, sets up the page table, performs other setup, then transfers execution to service handler in ring 3. In a particular embodiment, this may include deprivileging the execution mode and then transferring control to SMI handler 102. In various embodiments, the policy pages of the SPS 104 are supervisor pages that are read only (so even ring 0 can't modify these pages and ring 3 cannot access these pages).

SMM_INFO_TABLE provides one or more indications of where the policy pages (and other pages associated with SMM) are. For example, in the embodiment depicted, SMM_INFO_TABLE includes pointers to the page table, GDT, IDT, and policy pages for the MSR, Save State, and other registers (in other embodiments, the SMM_INFO_TABLE doesn't necessarily have explicit pointers to each of these, but may include enough information to derive the locations). In the embodiment depicted, the save state may be derived from the entrypoint (but isn't actually a part of the SMM_INFO_TABLE). The SMI exception handler may be a part of the SMI handler 102. The SMM exception handler may be part of the SPS 104.

In various embodiments, the SPS 104 protects itself from being tampered with by an SMI handler 102. As depicted, each SPS page may be marked as a supervisor page (e.g., Ring0 access only) in the page table. Additionally, the SPS may keep the code region, supervisor state, and policy (e.g., SMM entrypoint, GDT, IDT, page table, I/O bitmap, MSR policy, SMM exception handler, etc.) in read only pages such that the SMI handler 102 may not overwrite such code.

For the operating system context (e.g., float pointer registers such as MMX, XMM, YMM, ZMM, etc.) that do not need to be accessed from an SMI handler 102, the SPS 104 can save this context at the supervisor pages, scrub them at the SMI handler entry point, and restore them at the SMI exit.

In various embodiments, the SPS 104 make take additional steps to reduce the risk of exploitation by an SMI handler. For example, to reduce the risk of an ROP or JOP attack, the SPS may enable control flow enforcement technology (CET) (such as Intel CET) or a software implementation to enforce the execution flow.

In various embodiments, the hardware may be modified to accommodate an RSM instruction that is a supervisor privileged instruction, such that the user mode SMI handler 102 cannot bypass the context restoration work.

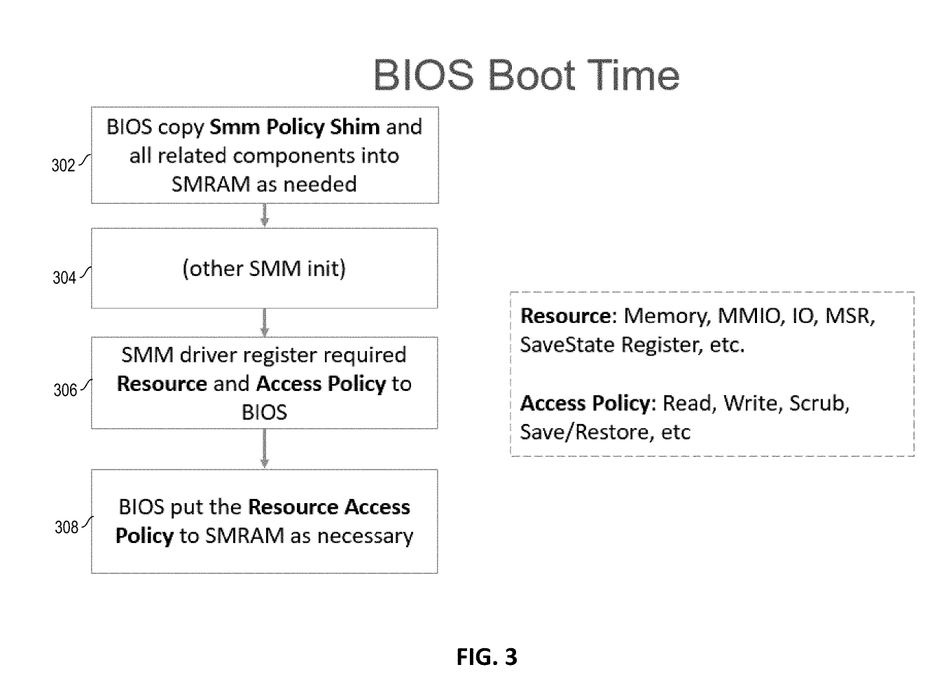

FIG. 3 illustrates a flow of a BIOS boot time (e.g., as performed during a POST procedure) in accordance with certain embodiments. At 302, BIOS may copy the SPS 104 (e.g., from flash memory) and related components into memory (e.g., system management random access memory (SMRAM)) at a location such that when an SMI occurs the SPS 104 will be executed.

At 304, other SMM initialization procedures may be performed. For example, SMM driver, service handlers, rendezvous code, data, or other suitable code may be used to initialize the SMM.

At 306, the SMM driver registers resource and access policy (e.g., as described above) to BIOS. For example, requested policies for each SMI handler may be stored (e.g., in flash memory), and the SMM driver may retrieve these resources and policies and/or derive such. For example, the MSR policy may be in flash as part of BIOS image while the page table may be dynamically constructed based at least in part on policy regarding which pages should be mapped. At 308, the BIOS may then store the resource access policy in memory (e.g., SMRAM).

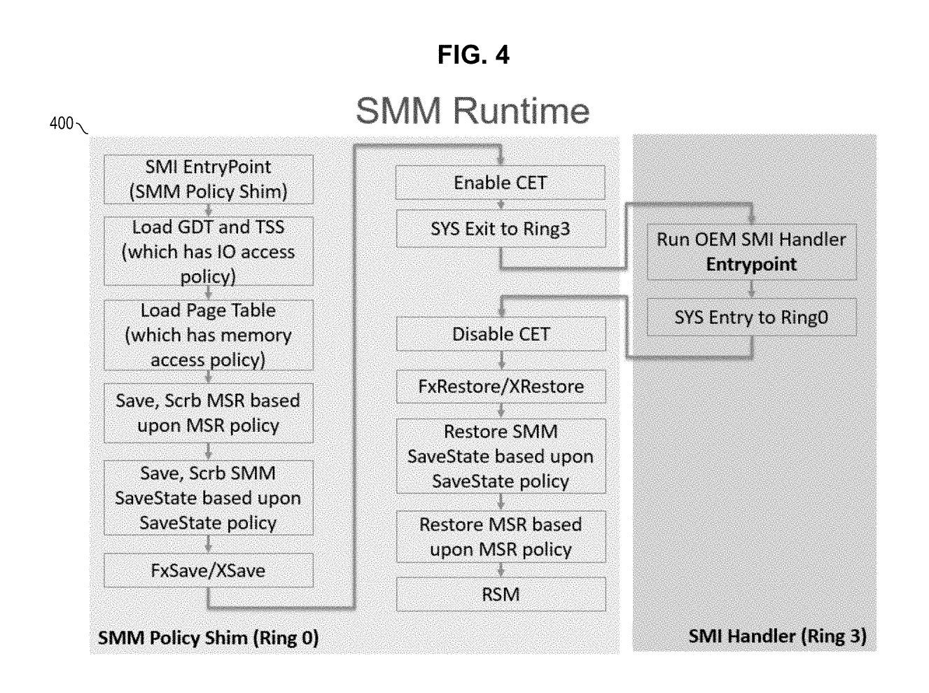

FIG. 4 illustrates a flow 400 for an SMM runtime in accordance with certain embodiments. FIG. 4 depicts a flow for both the SPS 104 and an SMI handler 102. The SMI entrypoint is entered and protected mode is turned on. The GDT and TSS (which includes the I/O access policy) are loaded. The page table (which specifies memory access policy) is loaded. Information stored in one or more MSRs may be saved and then scrubbed based on the MSR policy. The SMM save state may be saved and scrubbed based on the save state policy. Data stored in AVX or other registers may also be saved and scrubbed based on other policy. CET is then enabled. The system may then switch to a ring 3 privilege level. Processing then begins at the entrypoint of the SMI handler 102. When the SMI handler 102 is done executing the system may switch back to a ring 0 privilege level. CET may then be disabled, the AVX or other registers restored, the SMM save state restored, the MSR restored, and an RSM instruction may be executed. Control may then be passed back to the operating system.

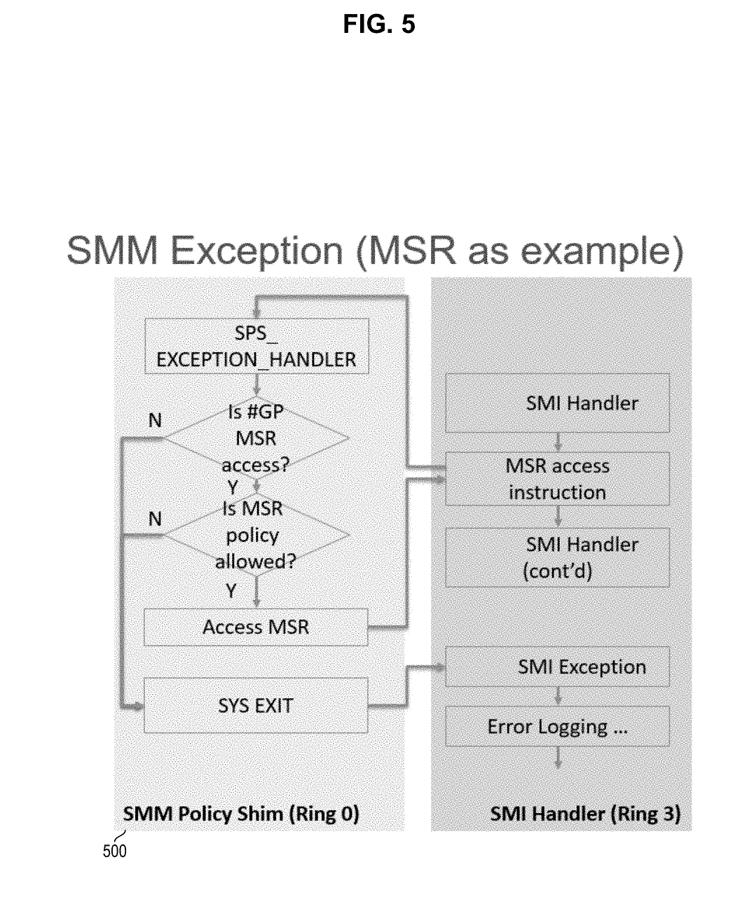

FIG. 5 illustrates a flow 500 for handling an SMM exception in accordance with certain embodiments. FIG. 5 depicts a flow for both the SPS 104 and an SMI handler 102. The flow of FIG. 5 depicts exception handling in conjunction with an MSR access. In some embodiments, an exception may be caused by an allowed resource access or a denied resource access, such as a memory or I/O access or a RDMSR/WRMSR access. If a memory access or I/O access is denied, the system may trigger a page fault (e.g., #PF Fault) or general protection fault (e.g., #GP Fault). In the embodiment depicted, an MSR access causes a #GP fault. The fault may invoke the SPS exception handler. If an MSR access is allowed (as defined by the MSR policy), the SPS 104 executes the instruction in ring 0 and returns the data to the original MSR access instruction in the SMI handler 102, and the SMI handler 102 resumes execution. If access to the resource is denied, the SPS 104 switches to the ring 3 SMI exception handler without returning the request data. In some embodiments, the SMI exception handler may log the error.

A similar flow may be followed when the SMI handler 102 attempts to access physical memory 106, MMIO 108, I/O 110, save state 114, or other resource. Policy for the particular resource requested is consulted and if the access is allowed, the access is granted and execution returns to the SMI handler 104. However, if the access is not granted, the access is denied and execution moves the SMI exception handler.

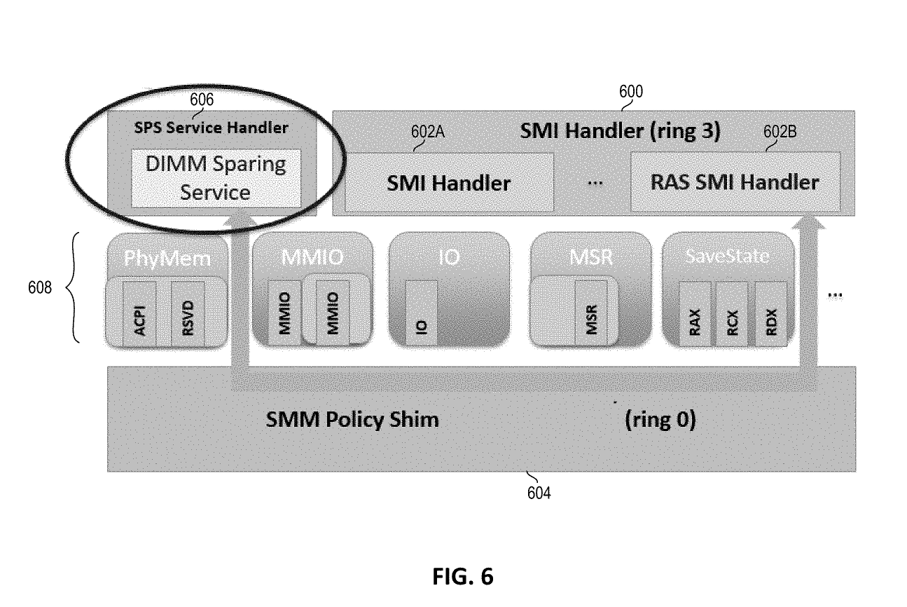

FIG. 6 illustrates a system for SMM with SMI isolation in accordance with certain embodiments. Various embodiments may provide additional system protection by isolating SMI handlers from each other. Particular embodiments may isolate SMI handlers for server platforms with Reliability Availability and Serviceability (RAS) support.

In various implementations, SMI handlers are not allowed to access operating system resources, such as the operating system memory region. However, in some server RAS scenarios, this is problematic because an RAS SMI handler may read and write all system memory (including operating system memory) to the same addresses to support a dual in-line memory module (DIMM) sparing feature. In order to perform DIMM sparing, if a DIMM begins to fail, a memory controller may be configured to switch contents over to a spare DIMM. Because the addresses may not be known a priori, the DIMM sparing service may require extra privileges to move the data. As such, an RAS SMI handler (e.g., 602B) may utilize a page table to access all system memory. Various embodiments may extend ring-based protection in SMM with SMI isolation capability allowing for support of RAS.

The system of FIG. 6 includes SMI handler domain 600 (comprising any number of SMI handlers (which may have any of the characteristics of the SMI handlers described above or other suitable characteristics), including SMI handler 602A and RAS SMI handler 602B), SPS 604 (which may have any of the characteristics of the SPS described above or other suitable characteristics), SPS service handler 606, and resources 608 (which may have any of the characteristics of the resources described above or other suitable characteristics).

In an embodiment, all traditional SMI handlers (e.g., 602A) may be deprivileged to a first ring 3 environment, a set of policies on which system resources (memory, MMIO, I/O, MSR, register context, etc.) may be accessed by SMI handlers may be defined, and a ring 0 SMM policy shim (SPS) 604 to enforce the policy may be provided. The first ring 3 environment may be similar to the ring 3 environment described in any of the various embodiments above and may be referred to herein as standard ring 3.

Additionally, a second environment may be provided as an SPS service handler 606. This second environment may have a protection policy that is different from the first environment. For example, the second environment may have full memory access. This second environment may be referred to herein as SPS service handler. This second environment may be a ring 3 environment with less restrictions than a standard ring 3 environment (and may have less restrictions than the standard ring 3 environment). Alternatively, the second environment may be a ring 0 environment.

The SPS service handler 606 may provide the service for the ring 3 RAS SMI handler 602B. In various embodiments, the service provided by the SPS service handler 606 is relatively limited in scope. Taking DIMM sparing as an example, the service provided by the SPS service handler 606 may just be to read memory and write memory back to the same physical address. In this manner, RAS may be enabled without exposing all operating system memory to ring 3. In various embodiments, the SPS service handler 606 does not include the complex logic to detect RAS flow from silicon register and platform general purpose input output (GPIO) register.

The SPS service handler 606 may be separated from the SPS 604 in order to limit the complexity and scope of the SPS 604. The SPS 604 may provide the service call to ring 3 and may have the capability to switch to the SPS service handler 606. Herein, the SPS 604 and the SPS service handler 606 together may be termed SPS Service Extension (SPS-SX). In various embodiment, the SPS service handler 606 runs in a separation ring 3 address space. In another embodiment, the SPS service handler 606 runs in a ring 0 address space to allow a unified page table. In various embodiments, the SPS-SX may provide ring 3 domain isolation.

In various embodiments, the SPS service handler 606 may perform any suitable functions for the SPS (RAS service is merely one example). The policy enforcement owner may allow any suitable predefined services to be performed by the SPS service handler 606.

The SPS-SX may segregate the tasks and the privilege in SMM. SPS-SX may also provide SMI handler domain isolation. It may provide avoidance of situations in which one problem in an SMI handler breaks the whole SMM and the system.

In various embodiments, a service handler may support server RAS feature for SMM ring based separation, or similar usages which fit this model. In an embodiment, the SPS service handler 606 isolates sensitive resources from the SMI handler (e.g., RAS SMI handler 602B). In another embodiment, different instances of ring 3 SMI handlers (e.g., 602A and 602B) are isolated using a ring 0 policy shim in SMM. In another embodiment, different resource access policies are used for different instances of ring 3 SMI handlers in SMM. In some embodiments, a system may switch between ring 3 SMI handlers in ring 0 policy shim in SMM. In another embodiment, an SMI ring 3 container may be used as a Trusted Execution Environment (TEE).

Referring to FIG. 6, the SPS-SX may run in a ring 0 environment. The SMI handlers 602A and 602B are deprivileged to ring 3. The system resources 608, such as physical memory, MMIO, I/O, MSR, register context, are split into two categories: the SMI accessible resources and the SMI non-accessible resources.

In FIG. 6, the SPS service handler 606 is a separated special domain with more privileges than the SMI handler domain 600. The SPS service handler 606 may access operating system resources. In various embodiments, the SPS service handler 606 may be in ring 0 or ring 3 (e.g., a ring 3 domain with increased capabilities relative to the ring 3 environment of the SMI handler). The SPS service handler 606 resource access policy may be referred to in SMM_SERVICE_INFO_TABLE, which in various embodiments may have a data structure similar to the SMM_INFO_TABLE described above. In some embodiments, the SMM_SERVICE_INFO_TABLE may refer to a different page table. As such, the service handler can access the full memory, and RAS DIMM sparing service can read and write memory to the same physical address without exposing the memory directly to ring 3 RAS SMI handler 602B. Since the SPS service handler 606 may access more resources than the SMI handler, the SPS service handler generally is, though is not required to be, provided by the same vendor as the SPS 604.

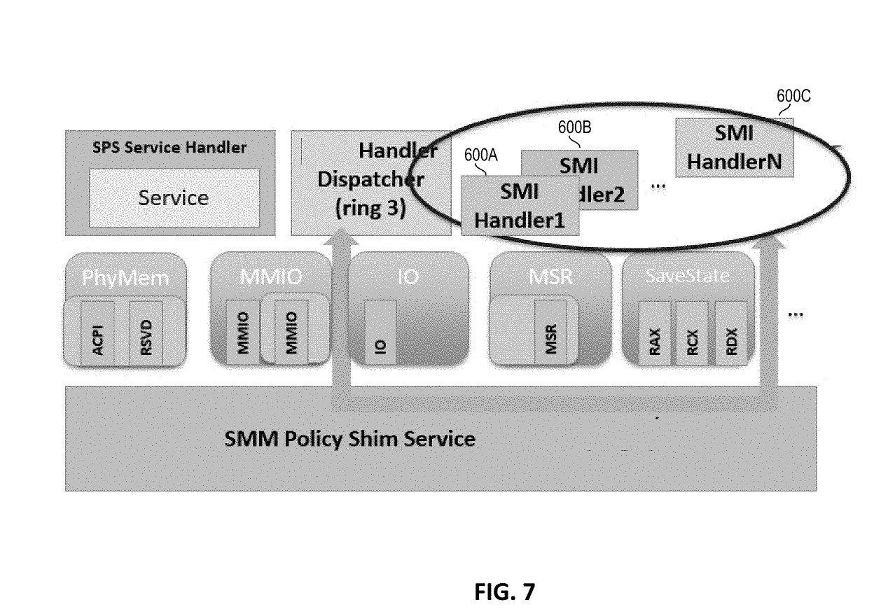

FIG. 7 illustrates an SPS-SX supporting multiple SMI handler domains 600A, 600B, and 600C in accordance with certain embodiments. In an embodiment, each SMI handler may have its own resource policy. For example, SMI handlerl cannot access the resources declared by SMI handler2 (or may access a different set of resources or may have different access policies for the resources). Thus, in various embodiments, these SMI handlers are isolated.

In FIG. 7, each ring 3 SMI handler is in its own domain and has its own resource policy. Each ring 3 SMI handler may have its own SMM_INFO_TABLE which includes indications of (e.g., pointers to) the resource access policy for the respective SMI handler. A particular embodiment includes a mechanism to discover the location of the SMM_INFO_TABLE for each ring 3 SMI handler, e.g., by using a locked hardware configuration. For example, the pointer of this table may be embedded to a fixed offset of the SMM entrypoint, or a special lockable MSR can be used to point to the SMM_INFO_TABLE (in a similar manner to that described above). In various embodiments, each SMI handler may have its own address space and execution environment.

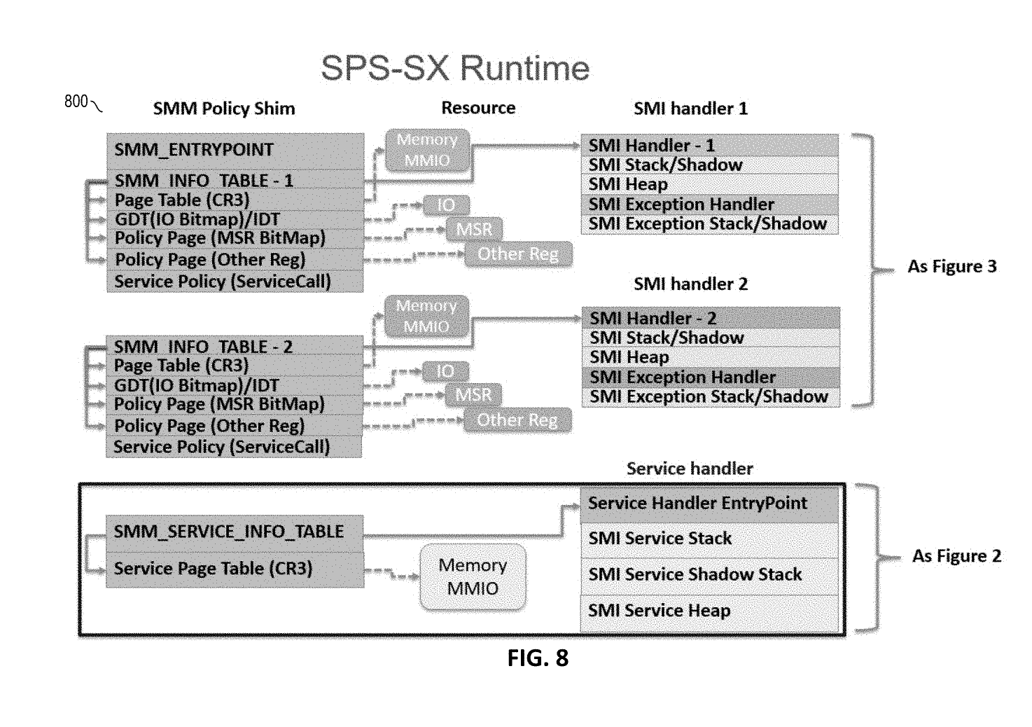

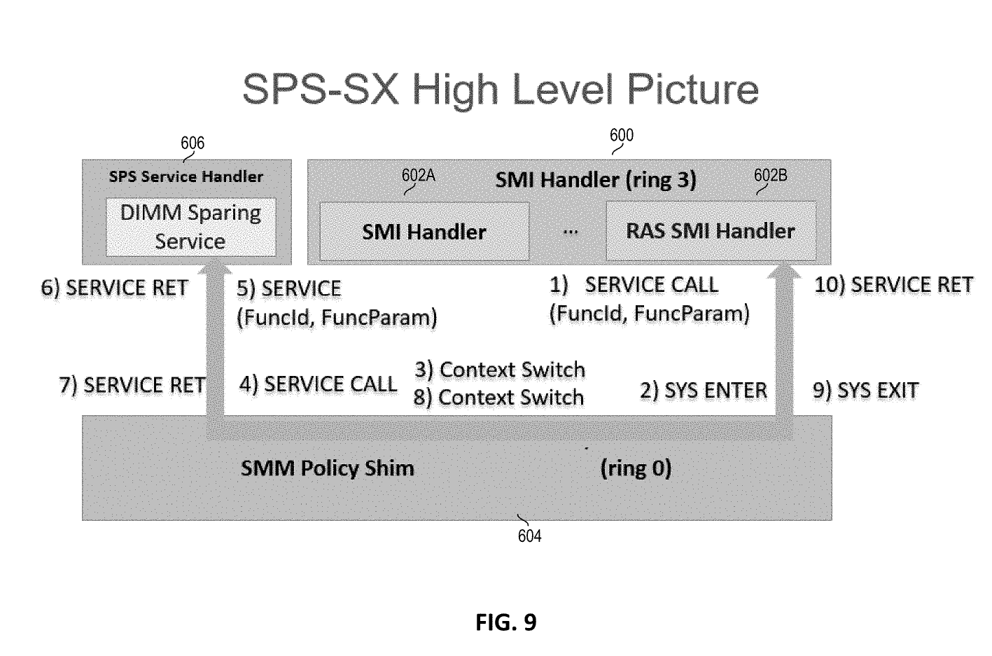

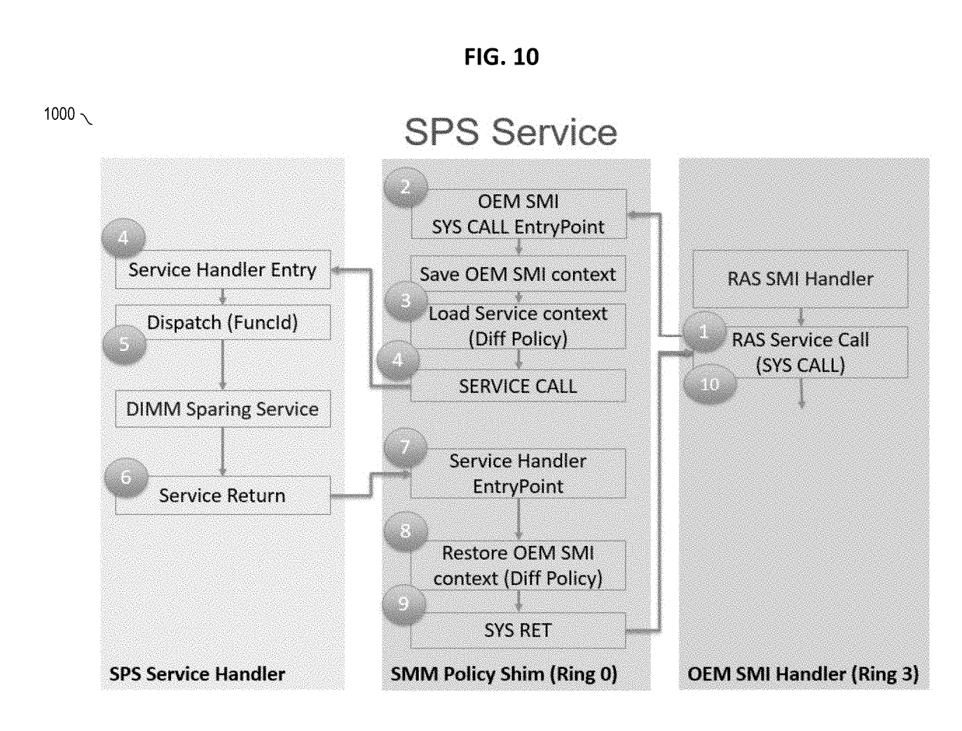

FIG. 8 illustrates a runtime 800 for a system implementing an SPS-SX in accordance with certain embodiments. The SPS-SX may be responsible for SPS service handler context switch. Sample flows are shown in FIGS. 9 and 10. FIG. 8 depicts two separate SMM info tables and thus two separate page tables (one for each SMI handler). The code at SMM Entrypoint can make a decision (e.g. based on a set bit or other indication) about which SMI handler should be run (policies may be different for each SMI handler). In one embodiment, an SMM info table may include a pointer to the next SMM info table in a chained manner to facilitate location of the correct SMM INFO TABLE.

FIGS. 9 and 10 illustrate flows for performing a function by an SPS service handler 606 in accordance with certain embodiments. Taking the RAS feature as an example, if the ring 3 RAS SMI handler 602B needs access to an operating system resource beyond the resource access granted to the RAS SMI handler 602B by SPS-SX (e.g., the RAS SMI handler 602B needs Read and Write Access to all memory), the RAS SMI handler 602B may use a service call. Then the ring 0 SPS-SX saves the ring 3 SMI context and loads the service handler context and switches to the SPS Service Handler 606.

If the SPS service handler is in Ring 3, the SPS-SX may load a new page table, e.g., in CR3. If the SPS service handler is in Ring 0, the SPS-SX may perform any of several options. In one embodiment, the SPS-SX leaves some fixed virtual address region whose page table entry is writeable for ring 0 such that the physical mapping can be changed. If the BIOS should include some read-only user pages for the ring 3 SMI handler, then the BIOS may also provide some supervisor read/write non-identity pages for the SPS service handler. As such the page table itself is configured as read-only. If BIOS doesn't include any read-only user pages for the ring 3 SMI handler, then the BIOS may use supervisor read/write identity pages for the SPS service handler. As such, the page table itself may still be read-only.

The SPS service handler 606 may run the request function based upon the function ID. For example, the function identified is the RAS DIMM sparing function in the depicted embodiment. After the DIMM sparing services finishes executing, the system switches back to the ring 3 SMI handler (e.g., RAS SMI handler 602B).

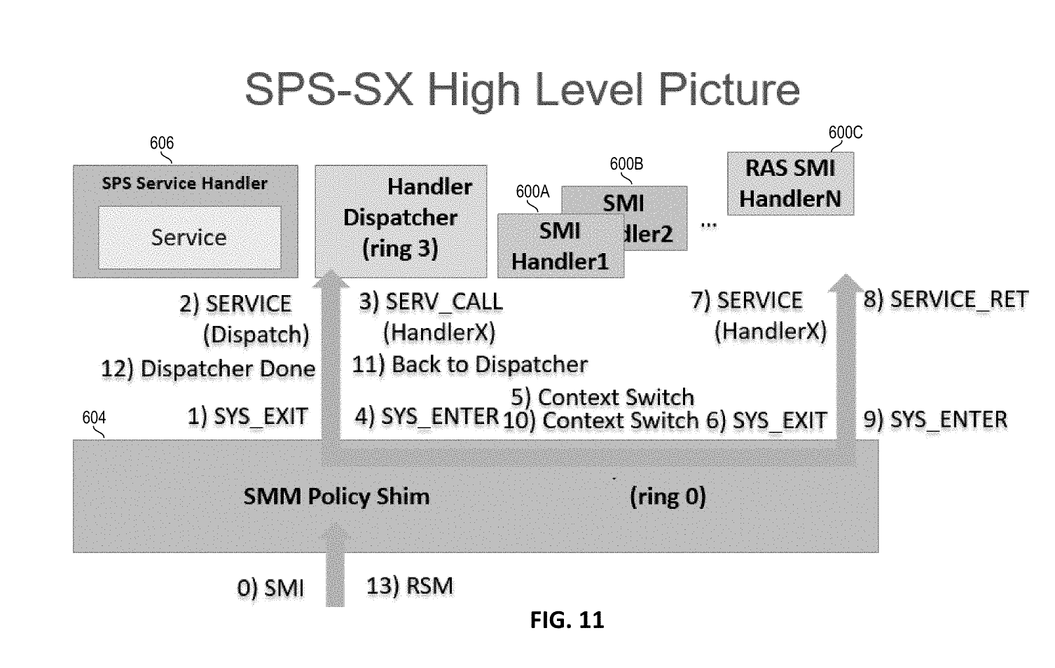

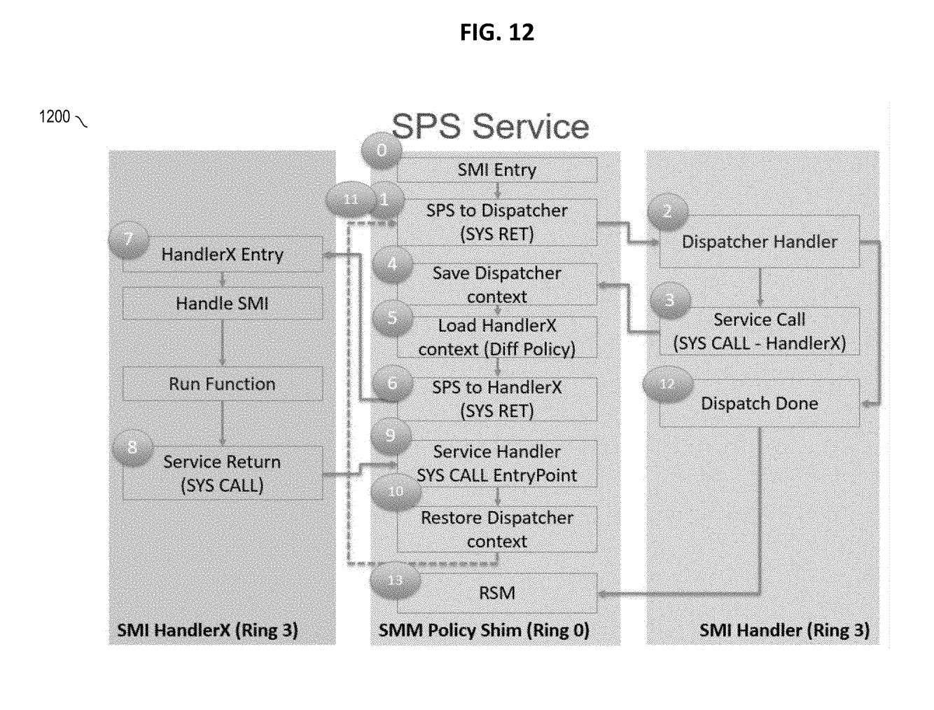

FIGS. 11 and 12 illustrate flows for performing a function by an SPS service handler 606 in a system comprising multiple SMI handler domains 600A-600C in accordance with certain embodiments. The SPS-SX is responsible for ring 3 environment switch. When the SMI occurs, the SPS-SX sets up the ring 0 protection environment, then switch to ring 3 Handler Dispatcher. This dispatcher inspects the SMI source and decides which SMI handler should be run to handle this SMI (the embodiment depicted assumes HandlerX). Then the system uses SPS-SX service call to dispatch HandlerX. After SPS-SX gets the service call, it switches the ring 3 context and loads the resource policy and use SYS_EXIT to enter SMI HandlerX.

Once SMI HandlerX finishes the work, it uses SERVICE_RET back to SPS-SX. Control is then given back to Handlers Dispatcher to dispatch the next SMI handler. After all, SMI handlers are dispatched, the dispatcher returns control back to SPS-SX and SPS-SX does RSM.

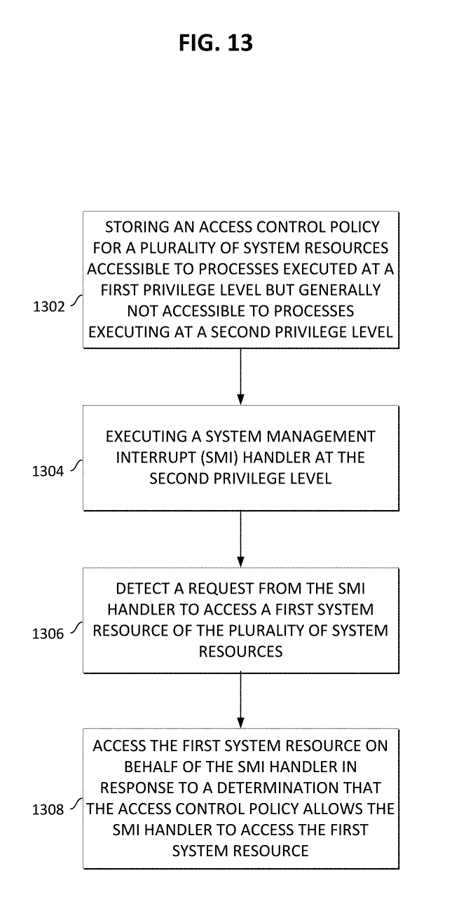

FIG. 13 depicts a flow for using a policy manager to control access to resources by an SMI handler in accordance with certain embodiments. At 1302, an access control policy is stored for a plurality of system resources accessible to processes executed at a first privilege level but generally not accessible to processes executing at a second privilege level. At 1304, a system management interrupt (SMI) handler is executed at the second privilege level. At 1306, a request from the SMI handler is detected, the request to access a first system resource of the plurality of system resources. At 1308, the first system resource is accessed on behalf of the SMI handler in response to a determination that the access control policy allows the SMI handler to access the first system resource.

Some of the operations illustrated in the flows of the above figures may be repeated, combined, modified or deleted where appropriate, and additional operations may also be added to the flow in various embodiments. Additionally, operations may be performed in any suitable order without departing from the scope of particular embodiments.

The figures below detail exemplary architectures and systems to implement embodiments of the above. For example, the SMI handlers, SMM policy shims, and SPS service handlers described above may be executed by any of the processors described below. In some embodiments, one or more hardware components and/or instructions described above are emulated as detailed below, or implemented as software modules.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

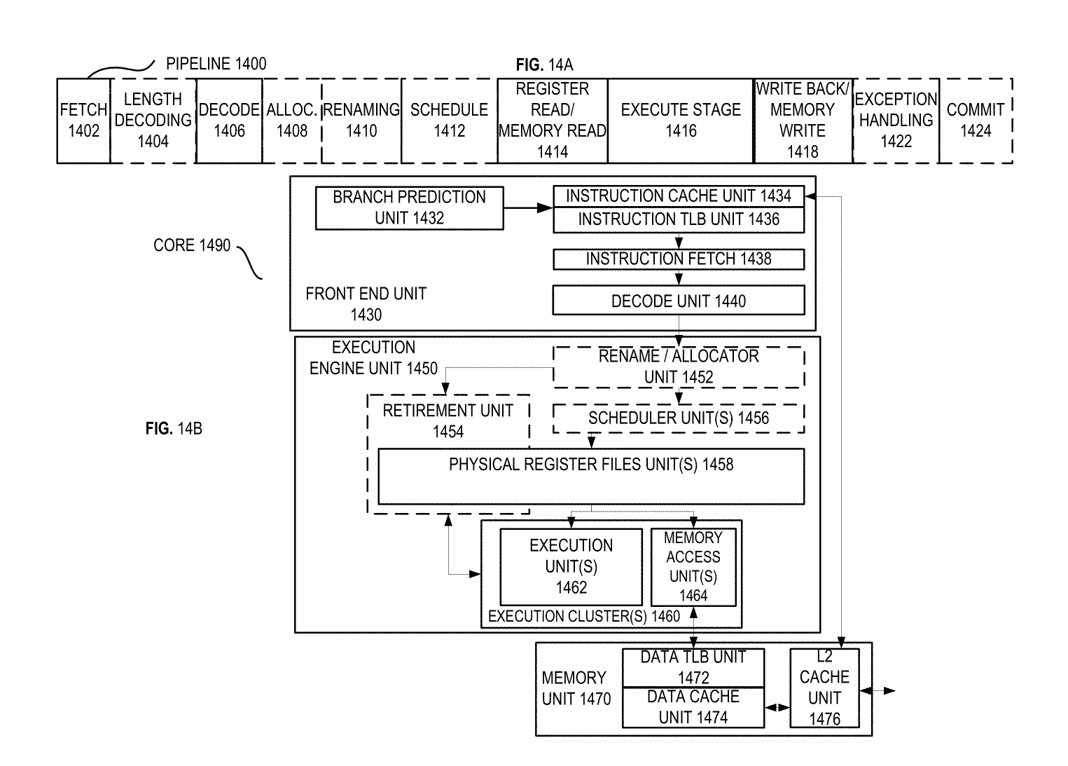

FIG. 14A is a block diagram illustrating both an exemplary in-order pipeline and an exemplary register renaming, out-of-order issue/execution pipeline according to embodiments of the disclosure. FIG. 14B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 14A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 14A, a processor pipeline 1400 includes a fetch stage 1402, a length decode stage 1404, a decode stage 1406, an allocation stage 1408, a renaming stage 1410, a scheduling (also known as a dispatch or issue) stage 1412, a register read/memory read stage 1414, an execute stage 1416, a write back/memory write stage 1418, an exception handling stage 1422, and a commit stage 1424.

FIG. 14B shows processor core 1490 including a front end unit 1430 coupled to an execution engine unit 1450, and both are coupled to a memory unit 1470. The core 1490 may be a reduced instruction set computing (RISC) core, a complex instruction set computing (CISC) core, a very long instruction word (VLIW) core, or a hybrid or alternative core type. As yet another option, the core 1490 may be a special-purpose core, such as, for example, a network or communication core, compression and/or decompression engine, coprocessor core, general purpose computing graphics processing unit (GPGPU) core, graphics core, or the like.

The front end unit 1430 includes a branch prediction unit 1432 coupled to an instruction cache unit 1434, which is coupled to an instruction translation lookaside buffer (TLB) 1436, which is coupled to an instruction fetch unit 1438, which is coupled to a decode unit 1440. The decode unit 1440 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1490 includes a microcode ROM or other medium that stores microcode for certain macroinstructions (e.g., in decode unit 1440 or otherwise within the front end unit 1430). The decode unit 1440 is coupled to a rename/allocator unit 1452 in the execution engine unit 1450.

The execution engine unit 1450 includes the rename/allocator unit 1452 coupled to a retirement unit 1454 and a set of one or more scheduler unit(s) 1456. The scheduler unit(s) 1456 represents any number of different schedulers, including reservations stations, central instruction window, etc. The scheduler unit(s) 1456 is coupled to the physical register file(s) unit(s) 1458. Each of the physical register file(s) units 1458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1458 comprises a vector registers unit, a write mask registers unit, and a scalar registers unit. These register units may provide architectural vector registers, vector mask registers, and general purpose registers. The physical register file(s) unit(s) 1458 is overlapped by the retirement unit 1454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1454 and the physical register file(s) unit(s) 1458 are coupled to the execution cluster(s) 1460. The execution cluster(s) 1460 includes a set of one or more execution units 1462 and a set of one or more memory access units 1464. The execution units 1462 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1456, physical register file(s) unit(s) 1458, and execution cluster(s) 1460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1464). It should also be understood that where separate pipelines are used, one or more of these pipelines may be out-of-order issue/execution and the rest in-order.

The set of memory access units 1464 is coupled to the memory unit 1470, which includes a data TLB unit 1472 coupled to a data cache unit 1474 coupled to a level 2 (L2) cache unit 1476. In one exemplary embodiment, the memory access units 1464 may include a load unit, a store address unit, and a store data unit, each of which is coupled to the data TLB unit 1472 in the memory unit 1470. The instruction cache unit 1434 is further coupled to a level 2 (L2) cache unit 1476 in the memory unit 1470. The L2 cache unit 1476 is coupled to one or more other levels of cache and eventually to a main memory.

By way of example, the exemplary register renaming, out-of-order issue/execution core architecture may implement the pipeline 1400 as follows: 1) the instruction fetch 1438 performs the fetch and length decoding stages 1402 and 1404; 2) the decode unit 1440 performs the decode stage 1406; 3) the rename/allocator unit 1452 performs the allocation stage 1408 and renaming stage 1410; 4) the scheduler unit(s) 1456 performs the schedule stage 1412; 5) the physical register file(s) unit(s) 1458 and the memory unit 1470 perform the register read/memory read stage 1414; the execution cluster 1460 perform the execute stage 1416; 6) the memory unit 1470 and the physical register file(s) unit(s) 1458 perform the write back/memory write stage 1418; 7) various units may be involved in the exception handling stage 1422; and 8) the retirement unit 1454 and the physical register file(s) unit(s) 1458 perform the commit stage 1424.

The core 1490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1490 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1434/1474 and a shared L2 cache unit 1476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

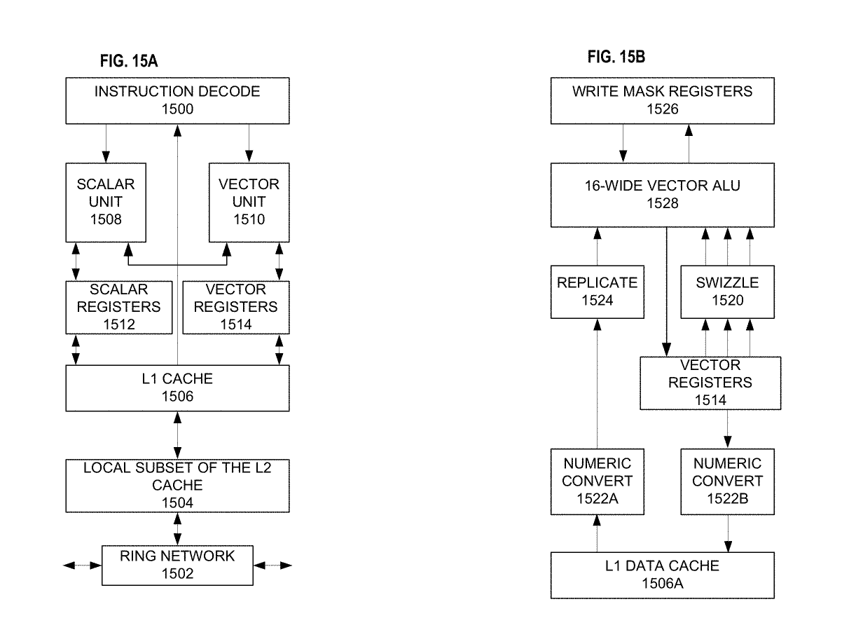

FIGS. 15A-B illustrate a block diagram of a more specific exemplary in-order core architecture, which core would be one of several logic blocks (potentially including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 15A is a block diagram of a single processor core, along with its connection to the on-die interconnect network 1502 and with its local subset of the Level 2 (L2) cache 1504, according to various embodiments. In one embodiment, an instruction decoder 1500 supports the x86 instruction set with a packed data instruction set extension. An L1 cache 1506 allows low-latency accesses to cache memory into the scalar and vector units. While in one embodiment (to simplify the design), a scalar unit 1508 and a vector unit 1510 use separate register sets (respectively, scalar registers 1512 and vector registers 1514) and data transferred between them is written to memory and then read back in from a level 1 (L1) cache 1506, alternative embodiments may use a different approach (e.g., use a single register set or include a communication path that allow data to be transferred between the two register files without being written and read back).

The local subset of the L2 cache 1504 is part of a global L2 cache that is divided into separate local subsets (in some embodiments one per processor core). Each processor core has a direct access path to its own local subset of the L2 cache 1504. Data read by a processor core is stored in its L2 cache subset 1504 and can be accessed quickly, in parallel with other processor cores accessing their own local L2 cache subsets. Data written by a processor core is stored in its own L2 cache subset 1504 and is flushed from other subsets, if necessary. The ring network ensures coherency for shared data. The ring network is bi-directional to allow agents such as processor cores, L2 caches and other logic blocks to communicate with each other within the chip. In a particular embodiment, each ring data-path is 1012-bits wide per direction.

FIG. 15B is an expanded view of part of the processor core in FIG. 15A according to embodiments. FIG. 15B includes an L1 data cache 1506A (part of the L1 cache 1506), as well as more detail regarding the vector unit 1510 and the vector registers 1514. Specifically, the vector unit 1510 is a 16-wide vector processing unit (VPU) (see the 16-wide ALU 1528), which executes one or more of integer, single-precision float, and double-precision float instructions. The VPU supports swizzling the register inputs with swizzle unit 1520, numeric conversion with numeric convert units 1522A-B, and replication with replication unit 1524 on the memory input. Write mask registers 1526 allow predicating resulting vector writes.

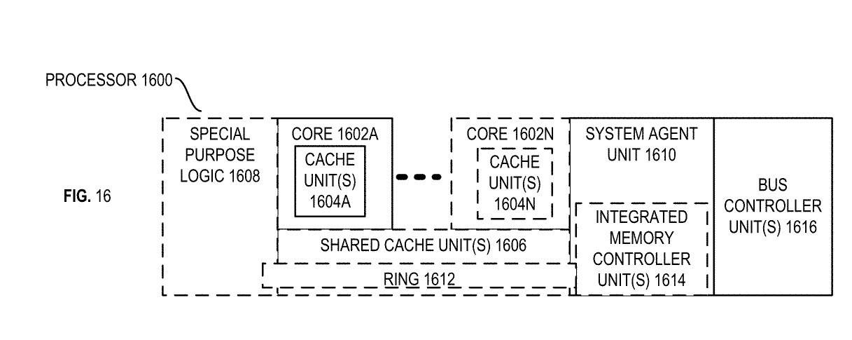

FIG. 16 is a block diagram of a processor 1600 that may have more than one core, may have an integrated memory controller, and may have integrated graphics according to various embodiments. The solid lined boxes in FIG. 16 illustrate a processor 1600 with a single core 1602A, a system agent 1610, and a set of one or more bus controller units 1616; while the optional addition of the dashed lined boxes illustrates an alternative processor 1600 with multiple cores 1602A-N, a set of one or more integrated memory controller unit(s) 1614 in the system agent unit 1610, and special purpose logic 1608.

Thus, different implementations of the processor 1600 may include: 1) a CPU with the special purpose logic 1608 being integrated graphics and/or scientific (throughput) logic (which may include one or more cores), and the cores 1602A-N being one or more general purpose cores (e.g., general purpose in-order cores, general purpose out-of-order cores, or a combination of the two); 2) a coprocessor with the cores 1602A-N being a large number of special purpose cores intended primarily for graphics and/or scientific (throughput); and 3) a coprocessor with the cores 1602A-N being a large number of general purpose in-order cores. Thus, the processor 1600 may be a general-purpose processor, coprocessor or special-purpose processor, such as, for example, a network or communication processor, compression and/or decompression engine, graphics processor, GPGPU (general purpose graphics processing unit), a high-throughput many integrated core (MIC) coprocessor (e.g., including 30 or more cores), embedded processor, or other fixed or configurable logic that performs logical operations. The processor may be implemented on one or more chips. The processor 1600 may be a part of and/or may be implemented on one or more substrates using any of a number of process technologies, such as, for example, BiCMOS, CMOS, or NMOS.

In various embodiments, a processor may include any number of processing elements that may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The memory hierarchy includes one or more levels of cache within the cores, a set or one or more shared cache units 1606, and external memory (not shown) coupled to the set of integrated memory controller units 1614. The set of shared cache units 1606 may include one or more mid-level caches, such as level 2 (L2), level 3 (L3), level 4 (L4), or other levels of cache, a last level cache (LLC), and/or combinations thereof. While in one embodiment a ring based interconnect unit 1612 interconnects the special purpose logic (e.g., integrated graphics logic) 1608, the set of shared cache units 1606, and the system agent unit 1610/integrated memory controller unit(s) 1614, alternative embodiments may use any number of well-known techniques for interconnecting such units. In one embodiment, coherency is maintained between one or more cache units 1606 and cores 1602A-N.

In some embodiments, one or more of the cores 1602A-N are capable of multi-threading. The system agent 1610 includes those components coordinating and operating cores 1602A-N. The system agent unit 1610 may include for example a power control unit (PCU) and a display unit. The PCU may be or include logic and components needed for regulating the power state of the cores 1602A-N and the special purpose logic 1608. The display unit is for driving one or more externally connected displays.

The cores 1602A-N may be homogenous or heterogeneous in terms of architecture instruction set; that is, two or more of the cores 1602A-N may be capable of executing the same instruction set, while others may be capable of executing only a subset of that instruction set or a different instruction set.

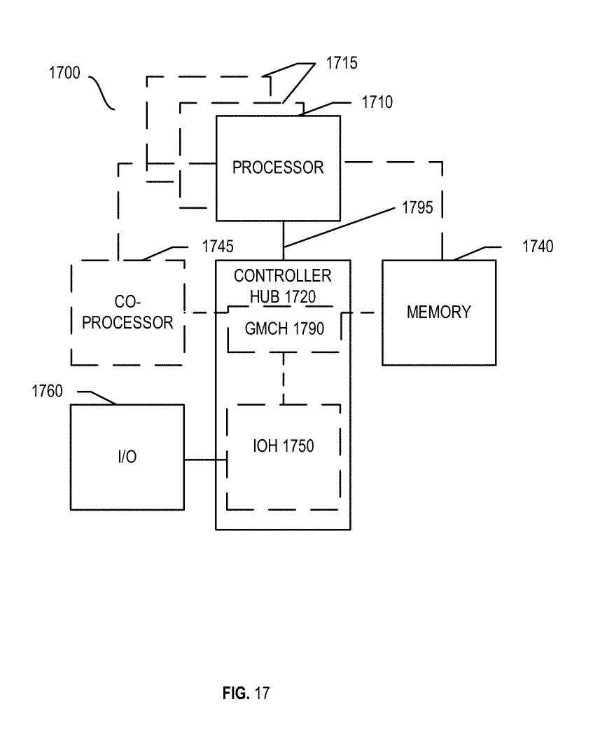

FIGS. 17-20 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable for performing the methods described in this disclosure. In general, a huge variety of systems or electronic devices capable of incorporating a processor and/or other execution logic as disclosed herein are generally suitable.

FIG. 17 depicts a block diagram of a system 1700 in accordance with one embodiment of the present disclosure. The system 1700 may include one or more processors 1710, 1715, which are coupled to a controller hub 1720. In one embodiment, the controller hub 1720 includes a graphics memory controller hub (GMCH) 1790 and an Input/Output Hub (IOH) 1750 (which may be on separate chips or the same chip); the GMCH 1790 includes memory and graphics controllers coupled to memory 1740 and a coprocessor 1745; the IOH 1750 couples input/output (I/O) devices 1760 to the GMCH 1790. Alternatively, one or both of the memory and graphics controllers are integrated within the processor (as described herein), the memory 1740 and the coprocessor 1745 are coupled directly to the processor 1710, and the controller hub 1720 is a single chip comprising the IOH 1750.

The optional nature of additional processors 1715 is denoted in FIG. 17 with broken lines. Each processor 1710, 1715 may include one or more of the processing cores described herein and may be some version of the processor 1600.

The memory 1740 may be, for example, dynamic random access memory (DRAM), phase change memory (PCM), other suitable memory, or any combination thereof. The memory 1740 may store any suitable data, such as data used by processors 1710, 1715 to provide the functionality of computer system 1700. For example, data associated with programs that are executed or files accessed by processors 1710, 1715 may be stored in memory 1740. In various embodiments, memory 1740 may store data and/or sequences of instructions that are used or executed by processors 1710, 1715.

In at least one embodiment, the controller hub 1720 communicates with the processor(s) 1710, 1715 via a multi-drop bus, such as a frontside bus (FSB), point-to-point interface such as QuickPath Interconnect (QPI), or similar connection 1795.

In one embodiment, the coprocessor 1745 is a special-purpose processor, such as, for example, a high-throughput MIC processor, a network or communication processor, compression and/or decompression engine, graphics processor, GPGPU, embedded processor, or the like. In one embodiment, controller hub 1720 may include an integrated graphics accelerator.

There can be a variety of differences between the physical resources 1710, 1715 in terms of a spectrum of metrics of merit including architectural, microarchitectural, thermal, power consumption characteristics, and the like.

In one embodiment, the processor 1710 executes instructions that control data processing operations of a general type. Embedded within the instructions may be coprocessor instructions. The processor 1710 recognizes these coprocessor instructions as being of a type that should be executed by the attached coprocessor 1745. Accordingly, the processor 1710 issues these coprocessor instructions (or control signals representing coprocessor instructions) on a coprocessor bus or other interconnect, to coprocessor 1745. Coprocessor(s) 1745 accept and execute the received coprocessor instructions.

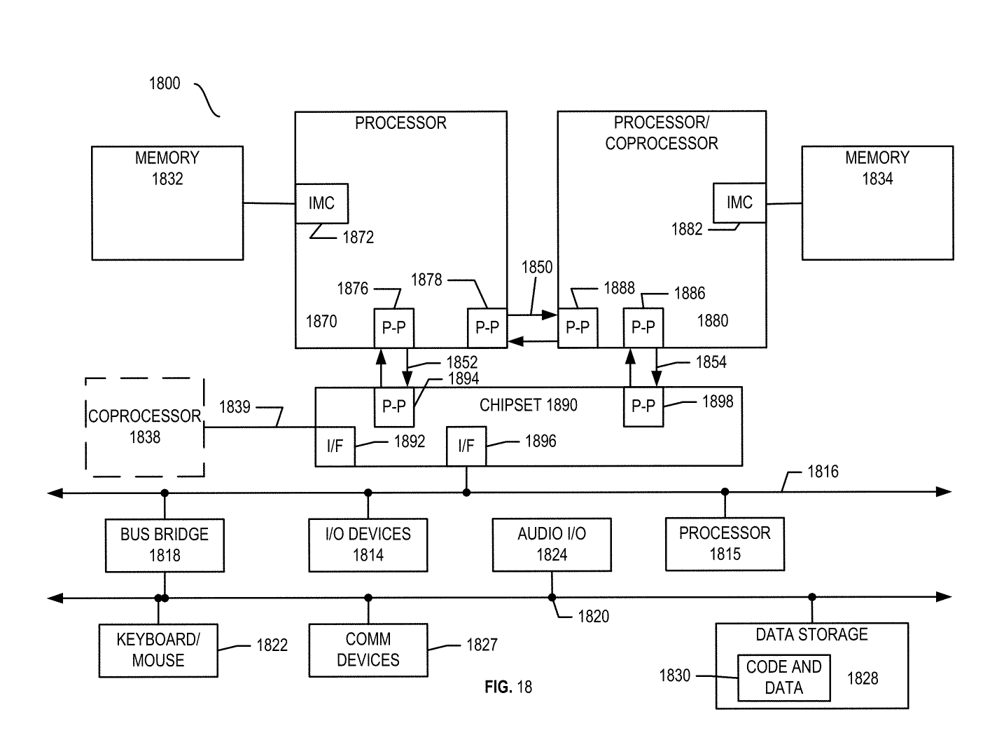

FIG. 18 depicts a block diagram of a first more specific exemplary system 1800 in accordance with an embodiment of the present disclosure. As shown in FIG. 18, multiprocessor system 1800 is a point-to-point interconnect system, and includes a first processor 1870 and a second processor 1880 coupled via a point-to-point interconnect 1850. Each of processors 1870 and 1880 may be some version of the processor 1600. In one embodiment of the disclosure, processors 1870 and 1880 are respectively processors 1710 and 1715, while coprocessor 1838 is coprocessor 1745. In another embodiment, processors 1870 and 1880 are respectively processor 1710 and coprocessor 1745.

Processors 1870 and 1880 are shown including integrated memory controller (IMC) units 1872 and 1882, respectively. Processor 1870 also includes as part of its bus controller unit's point-to-point (P-P) interfaces 1876 and 1878; similarly, second processor 1880 includes P-P interfaces 1886 and 1888. Processors 1870, 1880 may exchange information via a point-to-point (P-P) interface 1850 using P-P interface circuits 1878, 1888. As shown in FIG. 18, IMCs 1872 and 1882 couple the processors to respective memories, namely a memory 1832 and a memory 1834, which may be portions of main memory locally attached to the respective processors.

Processors 1870, 1880 may each exchange information with a chipset 1890 via individual P-P interfaces 1852, 1854 using point to point interface circuits 1876, 1894, 1886, 1898. Chipset 1890 may optionally exchange information with the coprocessor 1838 via a high-performance interface 1839. In one embodiment, the coprocessor 1838 is a special-purpose processor, such as, for example, a high-throughput MIC processor, a network or communication processor, compression and/or decompression engine, graphics processor, GPGPU, embedded processor, or the like.

A shared cache (not shown) may be included in either processor or outside of both processors, yet connected with the processors via a P-P interconnect, such that either or both processors' local cache information may be stored in the shared cache if a processor is placed into a low power mode.

Chipset 1890 may be coupled to a first bus 1816 via an interface 1896. In one embodiment, first bus 1816 may be a Peripheral Component Interconnect (PCI) bus, or a bus such as a PCI Express bus or another third generation I/O interconnect bus, although the scope of the present disclosure is not so limited.

As shown in FIG. 18, various I/O devices 1814 may be coupled to first bus 1816, along with a bus bridge 1818 which couples first bus 1816 to a second bus 1820. In one embodiment, one or more additional processor(s) 1815, such as coprocessors, high-throughput MIC processors, GPGPU's, accelerators (such as, e.g., graphics accelerators or digital signal processing (DSP) units), field programmable gate arrays, or any other processor, are coupled to first bus 1816. In one embodiment, second bus 1820 may be a low pin count (LPC) bus. Various devices may be coupled to a second bus 1820 including, for example, a keyboard and/or mouse 1822, communication devices 1827 and a storage unit 1828 such as a disk drive or other mass storage device which may include instructions/code and data 1830, in one embodiment. Further, an audio I/O 1824 may be coupled to the second bus 1820. Note that other architectures are contemplated by this disclosure. For example, instead of the point-to-point architecture of FIG. 18, a system may implement a multi-drop bus or other such architecture.

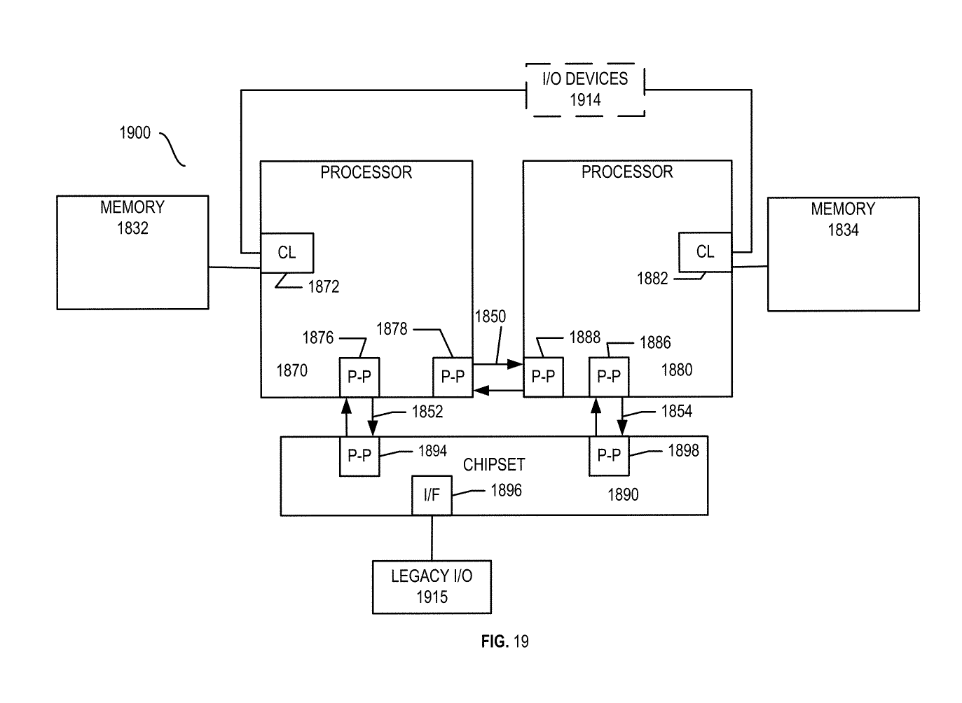

FIG. 19 depicts a block diagram of a second more specific exemplary system 1900 in accordance with an embodiment of the present disclosure. Similar elements in FIGS. 18 and 19 bear similar reference numerals, and certain aspects of FIG. 18 have been omitted from FIG. 19 in order to avoid obscuring other aspects of FIG. 19.

FIG. 19 illustrates that the processors 1870, 1880 may include integrated memory and I/O control logic (“CL”) 1872 and 1882, respectively. Thus, the CL 1872, 1882 include integrated memory controller units and include I/O control logic. FIG. 19 illustrates that not only are the memories 1832, 1834 coupled to the CL 1872, 1882, but also that I/O devices 1914 are also coupled to the control logic 1872, 1882. Legacy I/O devices 1915 are coupled to the chipset 1890.

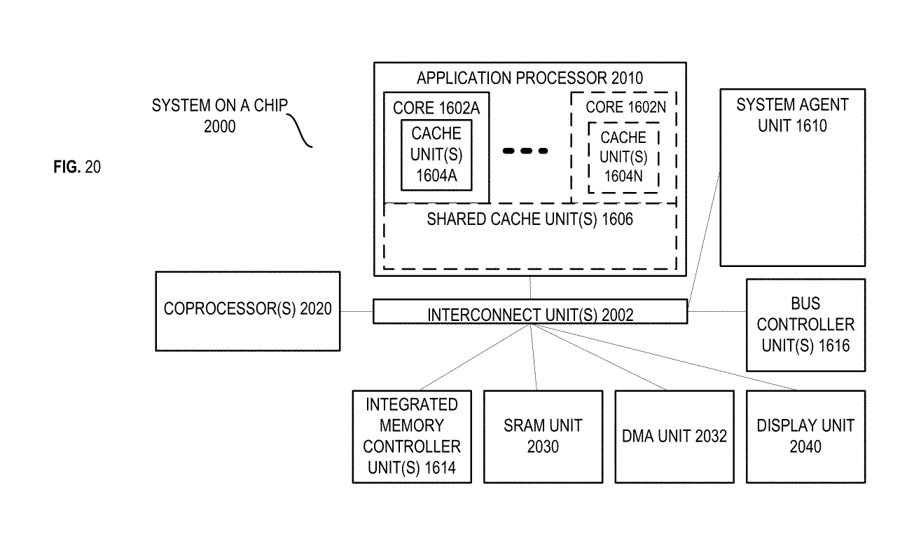

FIG. 20 depicts a block diagram of a SoC 2000 in accordance with an embodiment of the present disclosure. Similar elements in FIG. 16 bear similar reference numerals. Also, dashed lined boxes are optional features on more advanced SoCs. In FIG. 20, an interconnect unit(s) 2002 is coupled to: an application processor 2010 which includes a set of one or more cores 1602A-N and shared cache unit(s) 1606; a system agent unit 1610; a bus controller unit(s) 1616; an integrated memory controller unit(s) 1614; a set or one or more coprocessors 2020 which may include integrated graphics logic, an image processor, an audio processor, and a video processor; an static random access memory (SRAM) unit 2030; a direct memory access (DMA) unit 2032; and a display unit 2040 for coupling to one or more external displays. In one embodiment, the coprocessor(s) 2020 include a special-purpose processor, such as, for example, a network or communication processor, compression and/or decompression engine, GPGPU, a high-throughput MIC processor, embedded processor, or the like.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

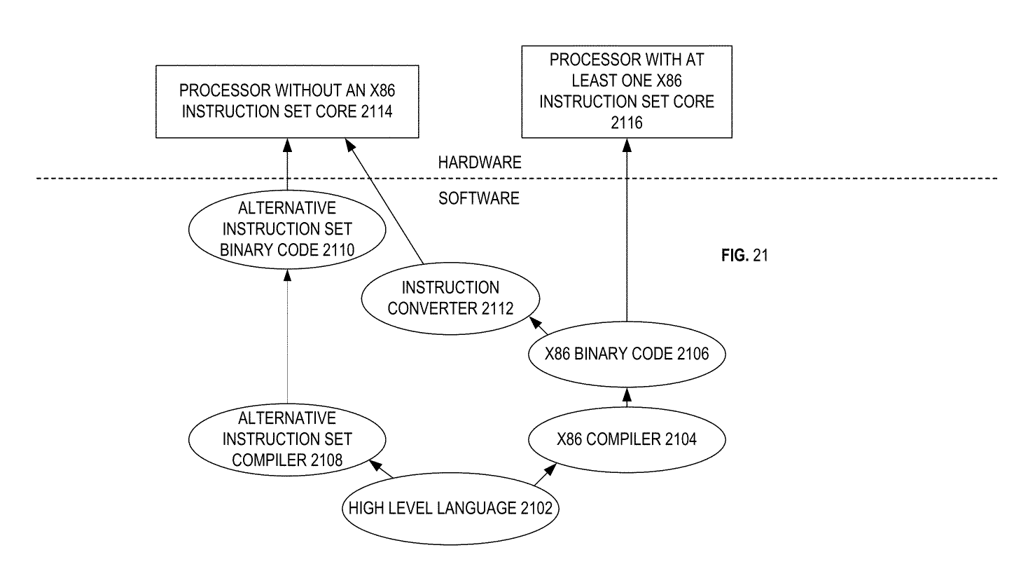

FIG. 21 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 21 shows a program in a high level language 2102 may be compiled using an x86 compiler 2104 to generate x86 binary code 2106 that may be natively executed by a processor with at least one x86 instruction set core 2116. The processor with at least one x86 instruction set core 2116 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2104 represents a compiler that is operable to generate x86 binary code 2106 (e.g., object code) that can, with or without additional linkage processing, be executed on the processor with at least one x86 instruction set core 2116. Similarly, FIG. 21 shows the program in the high level language 2102 may be compiled using an alternative instruction set compiler 2108 to generate alternative instruction set binary code 2110 that may be natively executed by a processor without at least one x86 instruction set core 2114 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2112 is used to convert the x86 binary code 2106 into code that may be natively executed by the processor without an x86 instruction set core 2114. This converted code is not likely to be the same as the alternative instruction set binary code 2110 because an instruction converter capable of this is difficult to make; however, the converted code will accomplish the general operation and be made up of instructions from the alternative instruction set. Thus, the instruction converter 2112 represents software, firmware, hardware, or a combination thereof that, through emulation, simulation or any other process, allows a processor or other electronic device that does not have an x86 instruction set processor or core to execute the x86 binary code 2106.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the manufacture of the described hardware.

In any representation of the design, the data representing the design may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Thus, one or more aspects of at least one embodiment may be implemented by representative instructions stored on a machine-readable medium which represents various logic within the processor, which when read by a machine causes the machine to fabricate logic to perform the techniques described herein. Such representations, often referred to as “IP cores” may be stored on a non-transitory tangible machine readable medium and supplied to various customers or manufacturing facilities to load into the fabrication machines that manufacture the logic or processor.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1830 illustrated in FIG. 18, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In various embodiments, the language may be a compiled or interpreted language.

The embodiments of methods, hardware, software, firmware or code set forth above may be implemented via instructions or code stored on a machine-accessible, machine readable, computer accessible, or computer readable medium which are executable (or otherwise accessible) by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information therefrom.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Logic may be used to implement any of the functionality of the various components such as an SMI handler, SPS, SPS Service Handler, SPS-SX, other component described herein, or any subcomponent of any of these components. “Logic” may refer to hardware, firmware, software and/or combinations of each to perform one or more functions. As an example, logic may include hardware, such as a micro-controller or processor, associated with a non-transitory medium to store code adapted to be executed by the micro-controller or processor. Therefore, reference to logic, in one embodiment, refers to the hardware, which is specifically configured to recognize and/or execute the code to be held on a non-transitory medium. Furthermore, in another embodiment, use of logic refers to the non-transitory medium including the code, which is specifically adapted to be executed by the microcontroller to perform predetermined operations. And as can be inferred, in yet another embodiment, the term logic (in this example) may refer to the combination of the hardware and the non-transitory medium. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components, which may be implemented by, e.g., transistors. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Often, logic boundaries that are illustrated as separate commonly vary and potentially overlap. For example, first and second logic may share hardware, software, firmware, or a combination thereof, while potentially retaining some independent hardware, software, or firmware.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

In at least one embodiment, a processor comprises a plurality of system resources accessible to processes executed at a first privilege level but generally not accessible to processes executing at a second privilege level; a memory to store an access control policy; and an execution unit to execute a system management interrupt (SMI) handler at the second privilege level; and execute a policy manager at the first privilege level, the policy manager to: detect a request from the SMI handler to access a first system resource of the plurality of system resources; and access the first system resource on behalf of the SMI handler in response to a determination that the access control policy allows the SMI handler to access the first system resource.

In an embodiment, the first privilege level is ring 0 and the second privilege level is ring 3. In an embodiment, the first system resource is a model specific register and the policy manager comprises an exception handler to lookup up the access control policy in response to a fault triggered by the request from the SMI handler. In an embodiment, the first system resource is a non-save state register. In an embodiment, the policy manager is further to enforce a control flow enforcement technology to prevent return-oriented programming (ROP) and jump-oriented programming (JOP) attacks. In an embodiment, the access control policy is a configuration table specific to the SMI handler that specifies access rights for the plurality of system resources. In an embodiment, the execution unit is further to execute a resume from System Management Mode (SMM) instruction at the second privilege level to enforce SMM context restore. In an embodiment, the execution unit is further to execute a service handler at a third privilege level that offers increased access to at least one of the plurality of system resources relative to the second privilege level, wherein the service handler is to access the at least one of the plurality of system resources on behalf of a second SMI handler that is executed at the second privilege level. In an embodiment, the service handler is read and write to operating system memory on behalf of the second SMI handler. In an embodiment, the memory is to store a plurality of access control policies, wherein each access control policy is specific to a respective SMI handler of a plurality of SMI handlers executed by the execution unit. In an embodiment, a container associated with the second privilege level may be used as a trusted execution environment (TEE). In an embodiment, the processor further comprises one or more of a battery communicatively coupled to the processor, a display communicatively coupled to the processor, or a network interface communicatively coupled to the processor.

In at least one embodiment, a method comprises storing an access control policy for a plurality of system resources accessible to processes executed at a first privilege level but generally not accessible to processes executing at a second privilege level; executing a system management interrupt (SMI) handler at the second privilege level; and executing a policy manager at the first privilege level, the policy manager to detect a request from the SMI handler to access a first system resource of the plurality of system resources; and access the first system resource on behalf of the SMI handler in response to a determination that the access control policy allows the SMI handler to access the first system resource.

In an embodiment, the first privilege level is ring 0 and the second privilege level is ring 3. In an embodiment, the first system resource is a model specific register and the policy manager comprises an exception handler to lookup up the access control policy in response to a fault triggered by the request from the SMI handler. In an embodiment, the access control policy is a configuration table specific to the SMI handler that specifies access rights for the plurality of system resources.

In at least one embodiment, at least one non-transitory machine readable storage medium has instructions stored thereon, the instructions when executed by a machine to cause the machine to store an access control policy for a plurality of system resources accessible to processes executed at a first privilege level but generally not accessible to processes executing at a second privilege level; execute a system management interrupt (SMI) handler at the second privilege level; and execute a policy manager at the first privilege level, the policy manager to detect a request from the SMI handler to access a first system resource of the plurality of system resources; and access the first system resource on behalf of the SMI handler in response to a determination that the access control policy allows the SMI handler to access the first system resource.

In an embodiment, the first privilege level is ring 0 and the second privilege level is ring 3. In an embodiment, the first system resource is a model specific register and the policy manager comprises an exception handler to lookup up the access control policy in response to a fault triggered by the request from the SMI handler. In an embodiment, the access control policy is a configuration table specific to the SMI handler that specifies access rights for the plurality of system resources.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor comprising:
a plurality of system resources accessible to processes executed at a first privilege level but generally not accessible to processes executing at a second privilege level;
a memory to store an access control policy; and
an execution unit to:
execute a system management interrupt (SMI) handler at the second privilege level; and
execute a policy manager at the first privilege level, the policy manager to:
detect a request from the SMI handler to access a first system resource of the plurality of system resources; and
access the first system resource on behalf of the SMI handler in response to a determination that the access control policy allows the SMI handler to access the first system resource.

2. The processor of claim 1, wherein the first privilege level is ring 0 and the second privilege level is ring 3.

3. The processor of claim 1, wherein the first system resource is a model specific register and the policy manager comprises an exception handler to lookup up the access control policy in response to a fault triggered by the request from the SMI handler.

4. The processor of claim 1, wherein the first system resource is a non-save state register.

5. The processor of claim 1, wherein the policy manager is further to enforce a control flow enforcement technology to prevent return-oriented programming (ROP) and jump-oriented programming (JOP) attacks.

6. The processor of claim 1, wherein the access control policy is a configuration table specific to the SMI handler that specifies access rights for the plurality of system resources.

7. The processor of claim 1, wherein the execution unit is further to execute a resume from System Management Mode (SMM) instruction at the second privilege level to enforce SMM context restore.

8. The processor of claim 1, the execution unit further to execute a service handler at a third privilege level that offers increased access to at least one of the plurality of system resources relative to the second privilege level, wherein the service handler is to access the at least one of the plurality of system resources on behalf of a second SMI handler that is executed at the second privilege level.

9. The processor of claim 8, wherein the service handler is read and write to operating system memory on behalf of the second SMI handler.

10. The processor of claim 1, wherein the memory is to store a plurality of access control policies, wherein each access control policy is specific to a respective SMI handler of a plurality of SMI handlers executed by the execution unit.

11. The processor of claim 1, wherein a container associated with the second privilege level may be used as a trusted execution environment (TEE).

12. The processor of claim 1, further comprising one or more of a battery communicatively coupled to the processor, a display communicatively coupled to the processor, or a network interface communicatively coupled to the processor.

13. A method comprising:
storing an access control policy for a plurality of system resources accessible to processes executed at a first privilege level but generally not accessible to processes executing at a second privilege level;
executing a system management interrupt (SMI) handler at the second privilege level; and
executing a policy manager at the first privilege level, the policy manager to:
detect a request from the SMI handler to access a first system resource of the plurality of system resources; and
access the first system resource on behalf of the SMI handler in response to a determination that the access control policy allows the SMI handler to access the first system resource.

14. The method of claim 13, wherein the first privilege level is ring 0 and the second privilege level is ring 3.

15. The method of claim 13, wherein the first system resource is a model specific register and the policy manager comprises an exception handler to lookup up the access control policy in response to a fault triggered by the request from the SMI handler.

16. The method of claim 13, wherein the access control policy is a configuration table specific to the SMI handler that specifies access rights for the plurality of system resources.

17. At least one non-transitory machine readable storage medium having instructions stored thereon, the instructions when executed by a machine to cause the machine to:
store an access control policy for a plurality of system resources accessible to processes executed at a first privilege level but generally not accessible to processes executing at a second privilege level;
execute a system management interrupt (SMI) handler at the second privilege level; and
execute a policy manager at the first privilege level, the policy manager to:
detect a request from the SMI handler to access a first system resource of the plurality of system resources; and
access the first system resource on behalf of the SMI handler in response to a determination that the access control policy allows the SMI handler to access the first system resource.

18. The at least one non-transitory machine readable storage medium of claim 17, wherein the first privilege level is ring 0 and the second privilege level is ring 3.

19. The at least one non-transitory machine readable storage medium of claim 17, wherein the first system resource is a model specific register and the policy manager comprises an exception handler to lookup up the access control policy in response to a fault triggered by the request from the SMI handler.

20. The at least one non-transitory machine readable storage medium of claim 17, wherein the access control policy is a configuration table specific to the SMI handler that specifies access rights for the plurality of system resources.
